(19) United States
(12) Patent Application Publication
(10) Pub. No.: US 2026/0133729 A1
(43) Pub. Date: May 14, 2026

(54) NON-TRANSITORY COMPUTER-READABLE STORAGE MEDIUM STORING PRINT CONTROL PROGRAM, PRINT CONTROL APPARATUS, AND CONTROL METHOD

(71) Applicant: SEIKO EPSON CORPORATION, Tokyo (JP)

(72) Inventor: Ryotaro KUBO, Minamiminowa-mura (JP)

(21) Appl. No.: 19/385,196

(22) Filed: Nov. 11, 2025

(30) Foreign Application Priority Data
Nov. 13, 2024 (JP) 2024-198146

(51) Int. Cl. G06F 3/12

(52) U.S. Cl. CPC G06F 3/1228; G06F 3/1205

(57) ABSTRACT

A non-transitory computer-readable storage medium storing a print control program that causes a computer to function as a print support application (PSA) for extending a general-purpose printer driver is configured as follows. The PSA includes a spool file acquiring section that acquires a plurality of spool files from the general-purpose printer driver, and an editing section that executes a plurality of editing processes on each of the plurality of spool files by parallel processing.

The present application is based on, and claims priority from JP Application Serial Number 2024-198146, filed November 13, 2024, the disclosure of which is hereby incorporated by reference herein in its entirety.

### BACKGROUND

### 1. Technical Field

The present disclosure relates to a non-transitory computer-readable storage medium storing a print control program, a print control apparatus, and a control method.

### 2. Related Art

JP-A-2024-18086 discloses an extension application for extending the functionality of an OS standard driver, which is built into an operating system (hereafter, OS) by default. The extension application is capable of editing spool files.

As described above, the extension application can edit spool files to implement various functions, such as N-up printing. However, executing all of the processes performed by the extension application takes a long time.

### SUMMARY

There is provided a non-transitory computer-readable storage medium storing a print control program that causes a computer to function as a print extension application for extending a general-purpose printer driver.

The print extension application includes a print data acquisition unit configured to acquire a plurality of pieces of print data from the general-purpose printer driver, and an editing unit configured to execute a plurality of editing processes on each of the plurality of pieces of print data by parallel processing.

There is provided a print control apparatus including a general-purpose printer driver, and a print extension application for extending the general-purpose printer driver. The print extension application includes a print data acquisition unit configured to acquire a plurality of pieces of print data from the general-purpose printer driver, and an editing unit configured to execute a plurality of editing processes on each of the plurality of pieces of print data by parallel processing.

There is provided a control method for a print control apparatus including a general-purpose printer driver and a print extension application for extending the general-purpose printer driver. The control method includes acquiring, by the print extension application, a plurality of pieces of print data from the general-purpose printer driver, and executing, by the print extension application, a plurality of editing processes on each of the plurality of pieces of print data by parallel processing.

### BRIEF DESCRIPTION OF THE DRAWINGS

FIG. 1 is a block diagram of a printing system (first embodiment).

FIG. 2 is a block diagram of a computer (first embodiment).

FIG. 3 illustrates a print-settings dialog of a general-purpose printer driver (first embodiment).

FIG. 4 illustrates a print-settings dialog of a print support application (PSA) (first embodiment).

FIG. 5 is a timetable illustrating the passage of time in an editing process performed by the PSA (comparative example).

FIG. 6 is a timetable illustrating the passage of time in an editing process performed by the PSA (first embodiment).

FIG. 7 illustrates the control flow of the general-purpose printer driver (first embodiment).

FIG. 8 illustrates the control flow of the PSA (first embodiment).

FIG. 9 illustrates the control flow of the PSA (first embodiment).

FIG. 10 illustrates the control flow of a first editing thread (first embodiment).

FIG. 11 illustrates the control flow of a second editing thread (first embodiment).

FIG. 12 illustrates the control flow of a third editing thread (first embodiment).

FIG. 13 is a block diagram of a computer (second embodiment).

FIG. 14 is a timetable illustrating the passage of time in an editing process performed by the PSA (second embodiment).

FIG. 15 is a timetable illustrating the passage of time in another editing process performed by the PSA (second embodiment).

### DESCRIPTION OF EMBODIMENTS

Embodiments of the present disclosure are described below. However, the scope of the disclosure as defined by the claims is not limited to the following embodiments. In addition, not all of the configurations described in the embodiments are essential as units that solve the problem. For clarity, certain descriptions and figures are omitted or simplified as appropriate. In each figure, the same elements are denoted by the same reference numerals, and repeated descriptions are omitted where appropriate.

For convenience, the following description is divided into multiple sections or embodiments, where appropriate. However, unless explicitly stated otherwise, these are not mutually independent but are related in that one may be a modified example, applied example, detailed description, or supplementary explanation, in whole or in part, of another. Additionally, when referring to a quantity (including number, value, amount, or range) of elements in the embodiments, the quantity is not limited to a specific number, for example, unless explicitly stated or inherently limited by theory. The number may be equal to, greater than, or less than a given value.

Additionally, in the embodiments described below, the components (including operation steps and the like) are not necessarily essential, for example, unless explicitly stated or inherently limited by theory. References to the shape, positional relationship, or the like of a component in the embodiments also encompass the substantially approximate or similar forms unless explicitly otherwise stated or obviously in theory. The same applies to the quantity (including number, value, amount, or range) mentioned above.

### First Embodiment

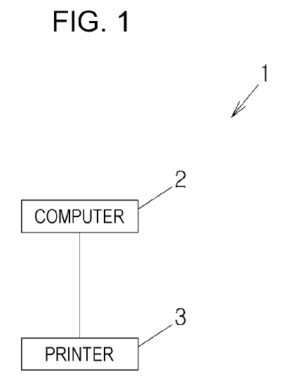

FIG. 1 is a block diagram illustrating an example of a printing system according to the present disclosure. A printing system 1 includes a computer 2 and a printer 3. The computer 2 and the printer 3 are communicatively coupled via a wired or wireless link. For example, the computer 2 may be communicatively coupled to the printer 3 over a local area network (LAN) such as a wireless LAN. Additionally, for example, the computer 2 may be communicatively coupled to the printer 3 via the Internet.

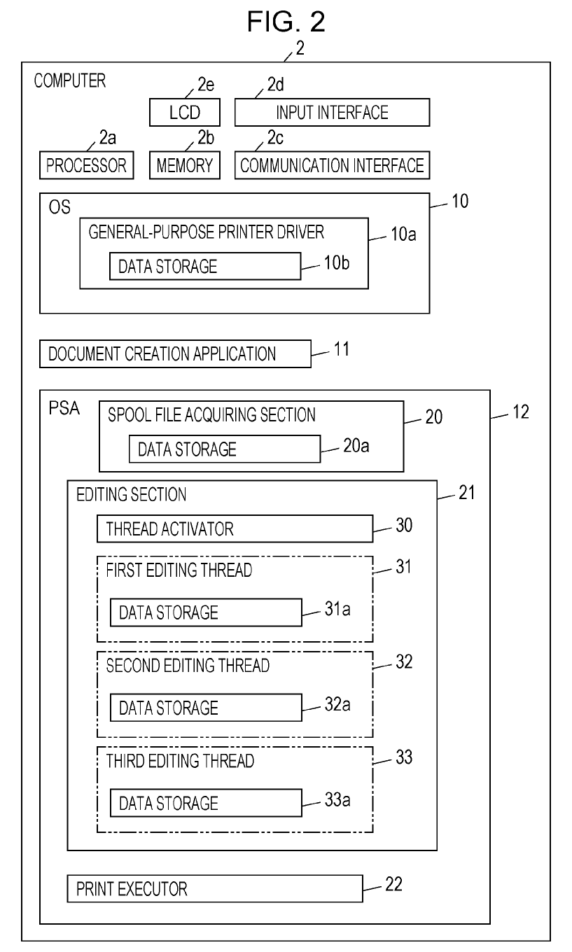

FIG. 2 is a block diagram of the computer 2. As illustrated in FIG. 2, the computer 2 includes a processor 2a, a memory 2b, a communication interface 2c, an input interface 2d, and a liquid crystal display (LCD) 2e.

The input interface 2d is typically a pointing device or a keyboard. The input interface 2d may also be a touch panel overlaid on the LCD 2e.

The processor 2a is any of various types of processors, such as a central processing unit (CPU), a graphics processing unit (GPU), or a field programmable gate array (FPGA). The memory 2b is a main storage device implemented by a random-access memory (RAM) or the like, or a secondary storage device implemented by a hard disk, a solid-state drive (SSD), a memory card, a read-only memory (ROM), or the like. The processor 2a can access the memory 2b. The processor 2a communicates with the printer 3 via the communication interface 2c. The memory 2b stores programs for implementing predetermined functions. The processor 2a reads and executes the programs stored in the memory 2b. The processor 2a thereby causes hardware components such as the processor 2a, the memory 2b, and the communication interface 2c to function as an operating system (OS) 10, a document creation application 11, and a print support application (PSA) 12.

The document creation application 11 is a specific example of a user application. The user application is not limited to the document creation application 11, and may be a presentation material creation application, or a spreadsheet application. The PSA 12 is a specific example of a print extension application.

The OS 10 is basic software for controlling the operation of the computer 2. The OS 10 may be, for example, Windows (registered trademark), but is not limited to this. The following description assumes that the OS 10 is Windows.

The OS 10 includes a general-purpose printer driver 10a. The general-purpose printer driver 10a provides standard printing functions included with Windows. The general-purpose printer driver 10a performs various processes in response to print requests from user applications, such as the document creation application 11. The general-purpose printer driver 10a is installed together with the OS 10 in the computer 2. The general-purpose printer driver 10a may be referred to as the OS 10's printing functionality.

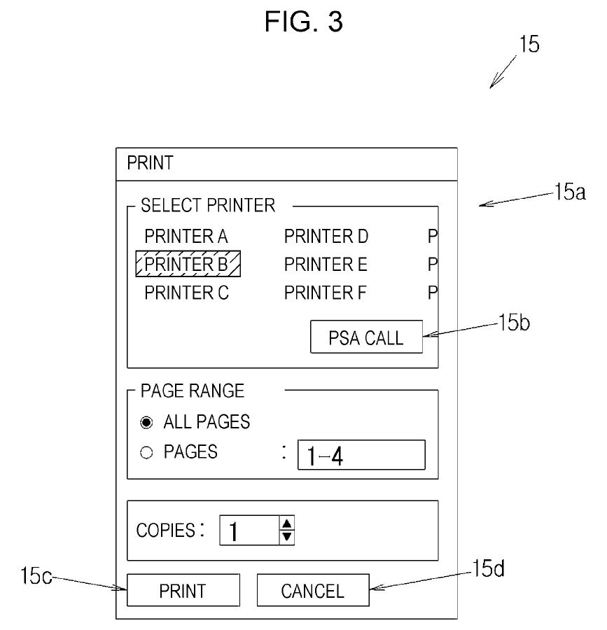

When the document creation application 11 sends a print request to the general-purpose printer driver 10a described above, the general-purpose printer driver 10a causes a Windows standard print-settings dialog 15, as illustrated in FIG. 3, to be displayed on the LCD 2e. The print-settings dialog 15 is also called a print dialog, print setup dialog, common print dialog, or system print dialog. The print request includes document data created by the user using the document creation application 11. In this embodiment, a document created by a user is assumed to include a plurality of pages for convenience. Thus, the document data contains a plurality of pieces of page data.

The print-settings dialog 15 typically includes a print setting unit 15a, a PSA call button 15b, a print execution button 15c, and a print cancel button 15d.

The print setting unit 15a displays various items to allow the user to input print settings. These items typically include a list box for selecting the printer, radio buttons and a text box for specifying the page range, and a text box for setting the number of copies.

The PSA call button 15b activates the PSA 12. When the PSA call button 15b is pressed after selecting a printer, the general-purpose printer driver 10a starts the PSA 12 and generates a plurality of spool files from the document data received from the document creation application 11. A spool file is a specific example of print data. The general-purpose printer driver 10a then stores and retains the plurality of generated spool files in a data storage 10b.

Each spool file includes XML Paper Specification (XPS) data (hereafter, also referred to as XPS data or simply as XPS) generated based on page data by the general-purpose printer driver 10a, and a Print Ticket as print setting information which indicates the print settings configured through the print setting unit 15a. Therefore, the general-purpose printer driver 10a generates spool files each including XPS data and a Print Ticket on a per-page basis from the document data. The Print Ticket is typically the same for a plurality of spool files. This is because the print setting unit 15a is originally configured to input print settings common to all pages, not to input different print settings page by page.

If the document creation application 11 has already generated XPS data, the general-purpose printer driver 10a acquires it from the document creation application 11 without regenerating it. Instead, if the document creation application 11 generates Graphics Device Interface data (hereafter, also referred to as GDI data or simply as GDI), the general-purpose printer driver 10a acquires the GDI data from the document creation application 11 and converts it into XPS data.

The print execution button 15c instructs the general-purpose printer driver 10a to execute printing.

The print cancel button 15d closes the print-settings dialog 15.

Referring back to FIG. 2, the PSA 12 includes a spool file acquiring section 20, an editing section 21, and a print executor 22.

The spool file acquiring section 20 acquires a plurality of spool files from the general-purpose printer driver 10a. The spool file acquiring section 20 is a specific example of a print data acquisition unit.

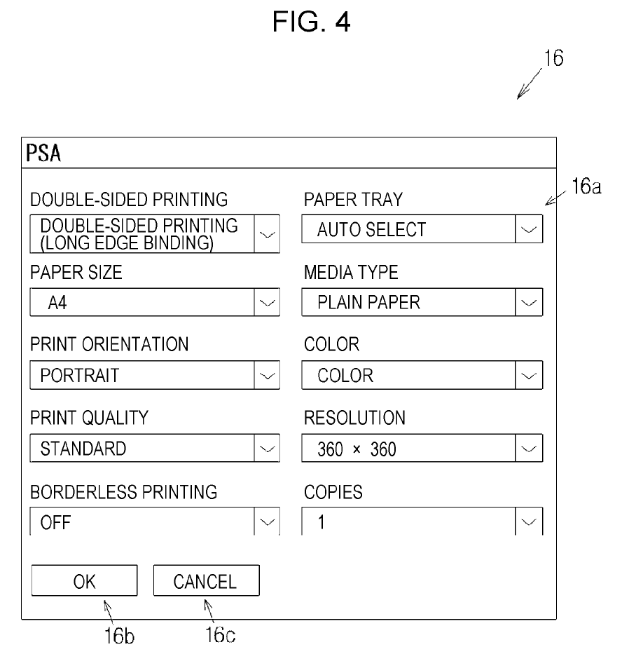

The PSA 12 causes a print-settings dialog 16 as illustrated in FIG. 4 to be displayed on the LCD 2e when the PSA 12 is activated. The print-settings dialog 16 typically includes a print setting unit 16a, a print execution button 16b, and a print cancel button 16c.

The print setting unit 16a is typically composed of a plurality of pull-down menus to allow the user to input the print settings. The print setting unit 16a displays a greater number of items than the print setting unit 15a provided by the general-purpose printer driver 10a as illustrated in FIG. 3.

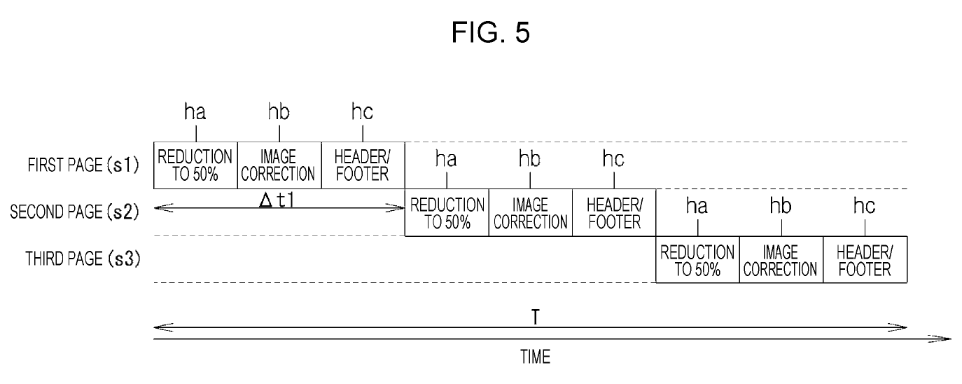

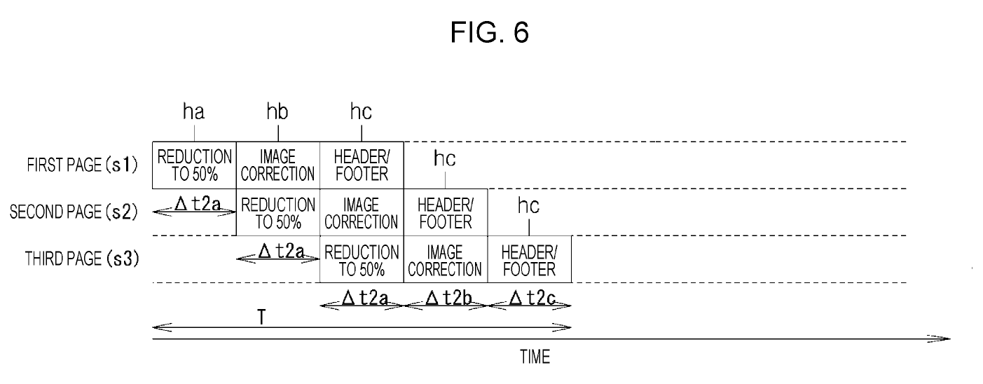

The editing section 21 executes a plurality of editing processes on each of the plurality of spool files by parallel processing. The editing section 21 is a specific example of an editing unit. The parallel processing by the editing section 21 will be explained below with reference to FIGS. 5 and 6. FIG. 5 illustrates a timetable in a case where the editing section 21 executes a plurality of editing processes by sequential processing. FIG. 6 illustrates a timetable in a case where the editing section 21 executes a plurality of editing processes by parallel processing.

In FIGS. 5 and 6, it is assumed that the editing section 21 executes a first editing process ha, a second editing process hb, and a third editing process hc as the plurality of editing processes. It is also assumed that the editing section 21 edits a first spool file s1, a second spool file s2, and a third spool file s3 as the plurality of spool files to be edited. The first editing process ha is, for example, an enlargement/reduction process. This enlargement/reduction process enlarges or reduces the size of an image indicated by the XPS data. The second editing process hb is, for example, an image correction process. This image correction process applies AutoPhotoFine (APF), Image Color Matching (ICM), manual settings, or the like to an image indicated by XPS data. The third editing process hc is, for example, a header/footer process. This header/footer process adds a header or footer to an image indicated by XPS data. The first to third spool files s1 to s3 respectively correspond to the first to third pages of a document.

As illustrated in FIG. 5, when the editing section 21 executes a plurality of editing processes by sequential processing (serial processing), the editing section 21 first executes the first editing process ha, the second editing process hb, and the third editing process hc, in that order, on the first spool file s1. The editing section 21 then executes the first editing process ha, the second editing process hb, and the third editing process hc, in that order, on the second spool file s2. Subsequently, the editing section 21 executes the first editing process ha, second editing process hb, and third editing process hc, in that order, on the third spool file s3. Accordingly, the total required time T for the editing section 21 to execute all the editing processes on all of the spool files is extremely long.

That is, assuming that the required time for executing all the editing processes (the first editing process ha, the second editing process hb, and the third editing process hc) on one spool file is defined as a required time Δt1, the total required time T is simply (the required time Δt1) × (the number of spool files). For example, when the document created by the user has 100 pages, the total required time T described above is (the required time Δt1) × 100.

In contrast, as illustrated in FIG. 6, when the editing section 21 executes the plurality of editing processes by parallel processing, the editing section 21 first executes the first editing process ha on the first spool file s1. Then, while executing the first editing process ha on the second spool file s2, the editing section 21 executes the second editing process hb on the first spool file s1. Next, while executing the second editing process hb on the second spool file s2 and executing the first editing process ha on the third spool file s3, the editing section 21 executes the third editing process hc on the first spool file s1. In this way, the editing section 21 simultaneously executes different editing processes on a plurality of spool files. As a result, the total required time T for the editing section 21 to execute all the editing processes on all of the spool files is much shorter than in the above-described sequential processing case.

That is, assuming that the required time for executing the first editing process ha on one spool file is defined as a required time Δt2a, the required time for executing the second editing process hb on one spool file is defined as a required time Δt2b, and the required time for executing the third editing process hc on one spool file is defined as a required time Δt2c, the total required time T is approximately (the required time Δt2a) × (the number of spool files) + the required time Δt2b + the required time Δt2c. For example, when the document created by the user has 100 pages, the total required time T is approximately (the required time Δt2a) × 100 + the required time Δt2b + Δt2c.

If the required times Δt2a, Δt2b, and Δt2c are substantially equal, the total required time T in the parallel processing illustrated in FIG. 6 is approximately one third of the total required time T in the sequential processing illustrated in FIG. 5.

The editing section 21 determines which type of editing process to execute on each spool file, based on the Print Ticket included in each spool file.

Additionally, when the editing section 21 executes a plurality of editing processes on each spool file, the editing section 21 determines the execution order according to a predetermined determination rule. Hereafter, a determination rule applied when the editing section 21 determines the execution order will be described.

The editing section 21 is configured, for example, to be capable of executing the following Editing Processes 1 to 17:

[Editing Process 1] Stamp mark processing: A mark or word such as "confidential" or "important" is printed as if stamped over print data.

[Editing Process 2] Enlargement/reduction processing: Printing is performed in an enlarged or reduced size.

[Editing Process 3] N-up processing: A plurality of pages are printed on a single sheet of paper.

[Editing Process 4] Poster printing processing: One page is divided over multiple sheets before printing.

[Editing Process 5] Portrait/landscape orientation selection processing: The page is printed in either portrait or landscape orientation.

[Editing Process 6] 180-degree rotation processing: Print data is rotated by 180 degrees before printing.

[Editing Process 7] Borderless printing processing: Printing is performed such that no margin (border) remains at the edges of the paper sheet.

[Editing Process 8] Automatic duplex printing processing: Automatic double-sided printing is performed.

[Editing Process 9] Horizontal mirror processing: Print data is mirrored horizontally (flipped left to right) before printing.

[Editing Process 10] Image correction processing: APF, ICM, manual settings, or the like are applied to the print data before printing.

[Editing Process 11] Character bolding processing: Character data is emboldened (that is, the stroke thickness is increased) before printing.

[Editing Process 12] Header/footer insertion processing: Header and/or footer text is inserted into the print data prior to printing.

[Editing Process 13] Collated printing processing: Collated copies of a document are printed.

[Editing Process 14] Blank page skip processing: Completely blank pages are detected and skipped so that they are not printed.

[Editing Process 15] Manual duplex processing: Manual double-sided printing is performed.

[Editing Process 16] Booklet printing processing: A multi-page document is printed in booklet format.

[Editing Process 17] Reverse-order processing: Printing is performed in reverse order.

Further, the determination rule mentioned above imposes the following constraint conditions.

Editing Processes 1 to 5 must be executed in the given order.

Editing Processes 6 to 11 must not be executed before Editing Processes 1 to 5.

Editing Processes 6 to 11 may be executed in a rearranged order.

Editing Processes 12 to 17 must not be executed before Editing Processes 1 to 11.

Editing Processes 12 to 17 must be executed in the given order.

In FIGS. 5 and 6, the execution order of the first editing process ha, the second editing process hb, and the third editing process hc is determined in accordance with the above-described determination rule.

Referring back to FIG. 2, the editing section 21 includes a thread activator 30. To implement the parallel processing described above, the thread activator 30 activates as many editing threads as there are editing processes defined in the Print Ticket. As illustrated in FIGS. 5 and 6, the editing section 21 activates a first editing thread 31 capable of executing the first editing process ha, a second editing thread 32 capable of executing the second editing process hb, and a third editing thread 33 capable of executing the third editing process hc. Accordingly, the PSA 12 includes the first editing thread 31, the second editing thread 32, and the third editing thread 33. These threads simultaneously execute different editing processes on different spool files, thereby implementing the parallel processing described above.

The print executor 22 converts the spool files edited by the editing section 21 into path data, and outputs the path data to the printer 3. As a result, the printer 3 performs printing in accordance with the path data.

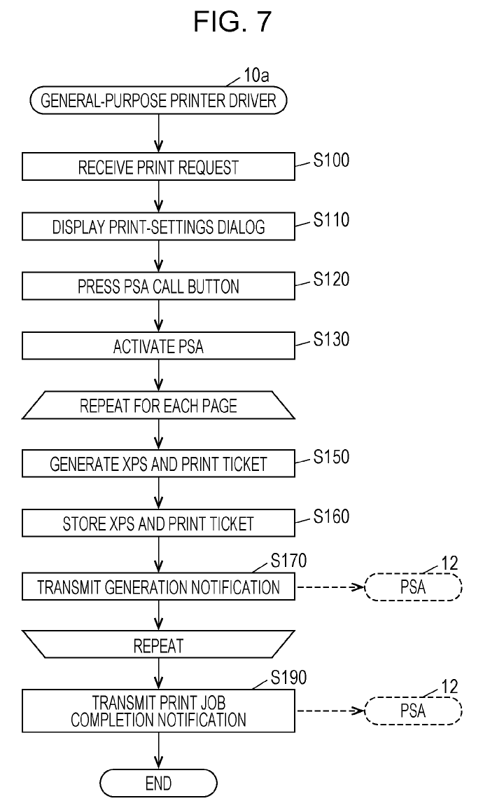

With reference to FIGS. 7 to 12, the operations of the printing system 1 for implementing the parallel processing described above will now be described in detail.

### General-purpose Printer Driver 10a

First, as illustrated in FIG. 7, the general-purpose printer driver 10a receives a print request from the document creation application 11 (S100). Next, the general-purpose printer driver 10a causes the print-settings dialog 15 to be displayed on the LCD 2e (S110). When the PSA call button 15b is pressed in the print-settings dialog 15 (S120), the general-purpose printer driver 10a activates the PSA 12 (S130). Then, the general-purpose printer driver 10a repeats steps S150 to S170 for each page of the document data included in the print request. Specifically, the general-purpose printer driver 10a generates XPS data and a Print Ticket on a per-page basis (S150), stores and retains the generated XPS data and Print Ticket in the data storage 10b (S160), and transmits a generation notification to the PSA 12 (S170). In response to the completion of the steps S150 to S170 for all the pages, the general-purpose printer driver 10a transmits a print job completion notification to the PSA 12 (S190).

### PSA 12

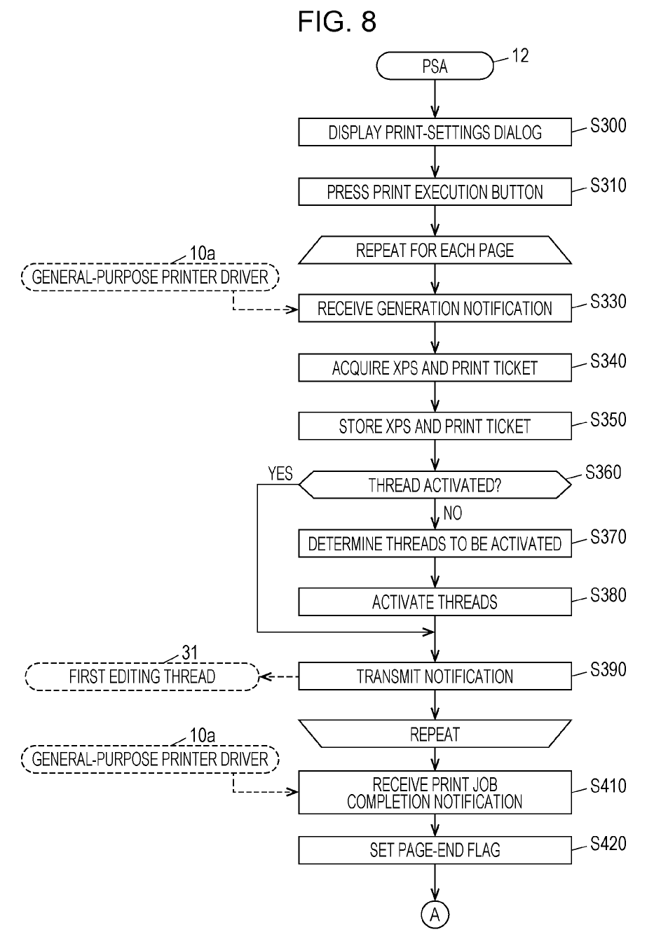

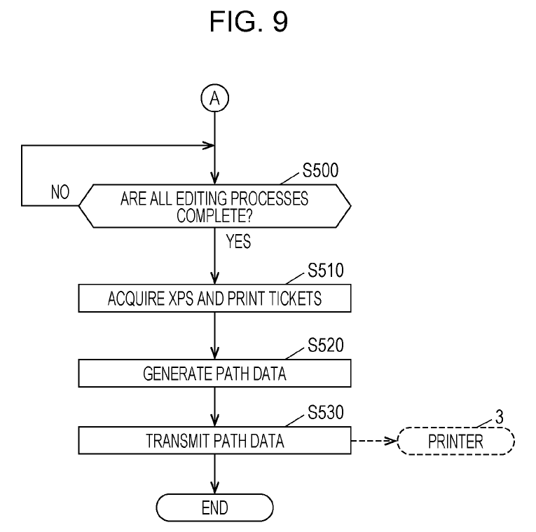

In step S130 of FIG. 7, the general-purpose printer driver 10a activates the PSA 12. Then, as illustrated in FIG. 8, the PSA 12 causes the print-settings dialog 16 to be displayed on the LCD 2e (S300). When the print execution button 16b is pressed in the print-settings dialog 16 (S310), the PSA 12 repeats steps S330 to step S390 for each page of the document data included in the print request. Specifically, upon receiving a generation notification from the general-purpose printer driver 10a (S330), the PSA 12 acquires one spool file (XPS data and Print Ticket) from the general-purpose printer driver 10a (S340) and stores the spool file in the data storage 20a (S350). Next, the thread activator 30 of the PSA 12 determines whether a thread for the editing process has already been activated (S360). If no editing thread has been activated (S360: NO), the thread activator 30 determines a plurality of editing threads to be activated based on the Print Ticket included in the spool file acquired by the spool file acquiring section 20 (S370), activates the determined plurality of editing threads (S380), and proceeds to step S390. Here, for convenience of description, it is assumed that the thread activator 30 activates the first editing thread 31, the second editing thread 32, and the third editing thread 33 illustrated in FIG. 2. If an editing thread has already been activated (S360: YES), the thread activator 30 proceeds directly to step S390. In step S390, the editing section 21 transmits a notification to the first editing thread 31. Accordingly, the editing section 21 transmits a notification to the first editing thread 31 each time the PSA 12 acquires a spool file from the general-purpose printer driver 10a. After completing steps S330 to S390 for all the pages, the PSA 12 receives a print job completion notification from the general-purpose printer driver 10a (S410), sets a page-end flag (S420), and proceeds to step S500 illustrated in FIG. 9.

In step S500 of FIG. 9, the print executor 22 monitors the first editing thread 31, the second editing thread 32, and the third editing thread 33 to wait until the completion of all the editing processes for all the spool files (S500: NO). If all the editing processes for all the spool files are complete (S500: YES), the print executor 22 acquires a plurality of edited spool files from the third editing thread 33 (S510), generates a plurality of pieces of path data based on the plurality of spool files (S520), transmits the plurality of pieces of generated path data to the printer 3 (S530), and terminates the process. As a result, the printer 3 prints document data generated by the user using the document creation application 11.

Next, the operations of the first editing thread 31, the second editing thread 32, and the third editing thread 33 will be described in order. In summary, in the order in which the spool file acquiring section 20 acquires the XPS data, each piece of XPS data is transferred from the data storage 20a to the first editing thread 31, which then executes the first editing process ha. The first editing thread 31 then transfers the XPS data to the second editing thread 32, which executes the second editing process hb. The second editing thread 32 then transfers the XPS data to the third editing thread 33, which executes the third editing process hc. Thereafter, all pieces of the XPS data are collected by the print executor 22 and are converted into path data.

### First Editing Thread 31

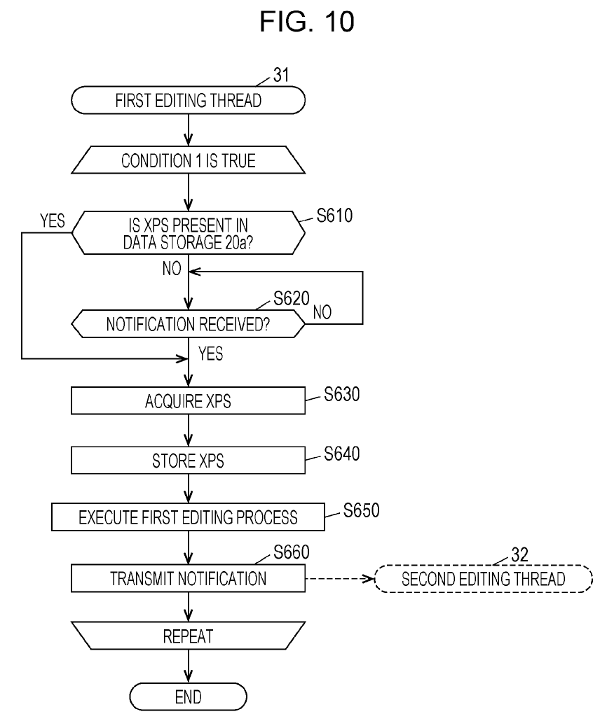

As illustrated in FIG. 10, the first editing thread 31 repeatedly executes steps S610 to S660 while Condition 1 is true. Condition 1 is a logical expression: (the page-end flag is not set, or the data storage 20a of the spool file acquiring section 20 holds XPS data).

First, the first editing thread 31 determines whether the XPS data is present in the data storage 20a of the spool file acquiring section 20 (S610). If it is determined that the XPS data is present in the data storage 20a of the spool file acquiring section 20 (S610: YES), the first editing thread 31 proceeds to step S630. In contrast, if it is determined that the XPS data is absent in the data storage 20a of the spool file acquiring section 20 (S610: NO), the first editing thread 31 waits until it receives a notification from the editing section 21 (S620: NO). If the first editing thread 31 receives such a notification (S620: YES), the first editing thread 31 proceeds to S630.

In step S630, the first editing thread 31 acquires XPS data from the data storage 20a of the spool file acquiring section 20 (S630), and stores the acquired XPS data in the data storage 31a (S640). Next, the first editing thread 31 executes the first editing process ha on the XPS data stored in the data storage 31a (S650), and transmits a notification to the second editing thread 32 (S660). When Condition 1 becomes false, the first editing thread 31 terminates the process.

### Second Editing Thread 32

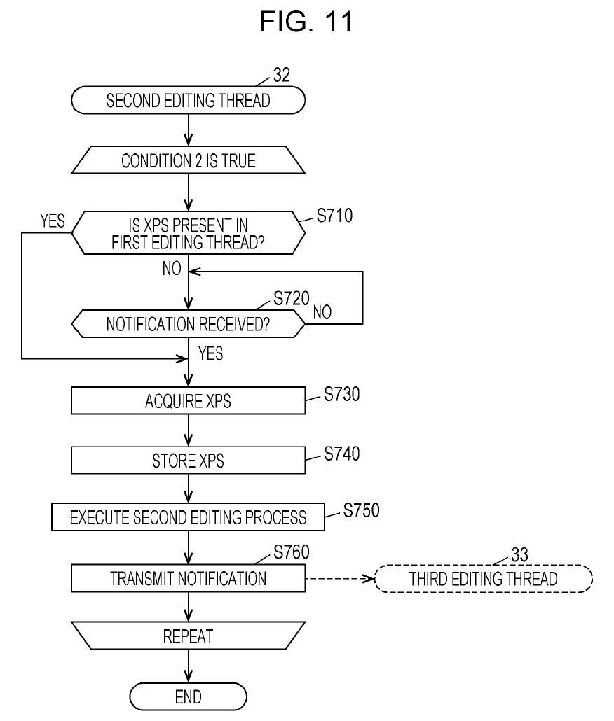

As illustrated in FIG. 11, the second editing thread 32 repeatedly executes steps S710 to S760 while Condition 2 is true. Condition 2 is a logical expression: (the page-end flag is not set, the data storage 31a of the first editing thread 31 holds XPS data, or the processing of the first editing thread 31 is complete).

First, the second editing thread 32 determines whether XPS data is present in the data storage 31a of the first editing thread 31 (S710). If it is determined that the XPS data is present in the data storage 31a of the first editing thread 31 (S710: YES), the second editing thread 32 proceeds to step S730. In contrast, if it is determined that the XPS data is absent in the data storage 31a of the first editing thread 31 (S710: NO), the second editing thread 32 waits until it receives a notification from the first editing thread 31 (S720: NO). If the second editing thread 32 receives such a notification (S720: YES), the second editing thread 32 proceeds to S730.

In step S730, the second editing thread 32 acquires the XPS data from the data storage 31a of the first editing thread 31 (S730), and stores the acquired XPS data in the data storage 32a (S740). Next, the second editing thread 32 executes the second editing process hb on the XPS data stored in the data storage 32a (S750), and transmits a notification to the third editing thread 33 (S760). When Condition 2 becomes false, the second editing thread 32 terminates the process.

### Third Editing Thread 33

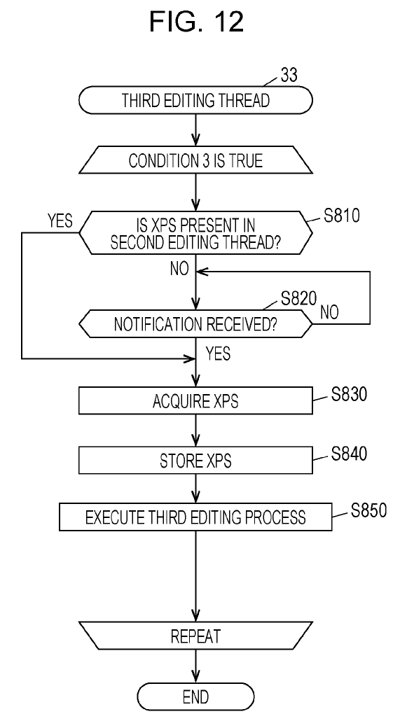

As illustrated in FIG. 12, the third editing thread 33 repeatedly executes steps S810 to S850 while Condition 3 is true. Condition 3 is a logical expression: (the page-end flag is not set, the data storage 32a of the second editing thread 32 holds XPS data, or the processing of the second editing thread 32 is complete).

First, the third editing thread 33 determines whether XPS data is present in the data storage 32a of the second editing thread 32 (S810). If it is determined that XPS data is present in the data storage 32a of the second editing thread 32 (S810: YES), the third editing thread 33 proceeds to step S830. In contrast, if it is determined that the XPS data is absent in the data storage 32a of the second editing thread 32 (S810: NO), the third editing thread 33 waits until it receives a notification from the second editing thread 32 (S820: NO). If the third editing thread 33 receives such a notification (S820: YES), the third editing thread 33 proceeds to step S830.

In step S830, the third editing thread 33 acquires the XPS data from the data storage 32a of the second editing thread 32 (S830), and stores the acquired XPS data in the data storage 33a (S840). Next, the third editing thread 33 executes the third editing process hc on the XPS data stored in the data storage 33a (S850). When Condition 3 becomes false, the third editing thread 33 terminates the process.

The first embodiment has been described above, and it has the following features.

That is, a non-transitory computer-readable storage medium storing a print control program that causes the computer 2 to function as the PSA 12 (the print extension application) for extending the general-purpose printer driver 10a is configured as follows. The PSA 12 includes the spool file acquiring section 20 (the print data acquisition unit) configured to acquire a plurality of spool files (the print data) from the general-purpose printer driver 10a, and the editing section 21 (the editing unit) configured to execute a plurality of editing processes on each of the plurality of spool files by parallel processing. This configuration enables a significant reduction in the time required to execute a plurality of editing processes on each of a plurality of spool files.

Additionally, the plurality of spool files include the first spool file s1 and the second spool file s2. The plurality of editing processes include the first editing process ha and the second editing process hb different from the first editing process ha. The editing section 21 executes the first editing process ha and the second editing process hb on the first spool file s1, and executes the first editing process ha and the second editing process hb on the second spool file s2. The configuration described above enables a plurality of editing processes to be executed on the spool files without omission.

Additionally, the editing section 21 includes the first editing thread 31 (first processing unit) configured to execute the first editing process ha, and the second editing thread 32 (second processing unit) configured to execute the second editing process hb. This configuration provides, for each editing process, a dedicated entity that executes the editing process.

Additionally, after the first editing thread 31 has executed the first editing process ha on the first spool file s1, the second editing thread 32 executes the second editing process hb on the first spool file s1 while the first editing thread 31 executes the first editing process ha on the second spool file s2. This configuration provides simultaneous execution of different editing processes on different spool files.

### Second Embodiment

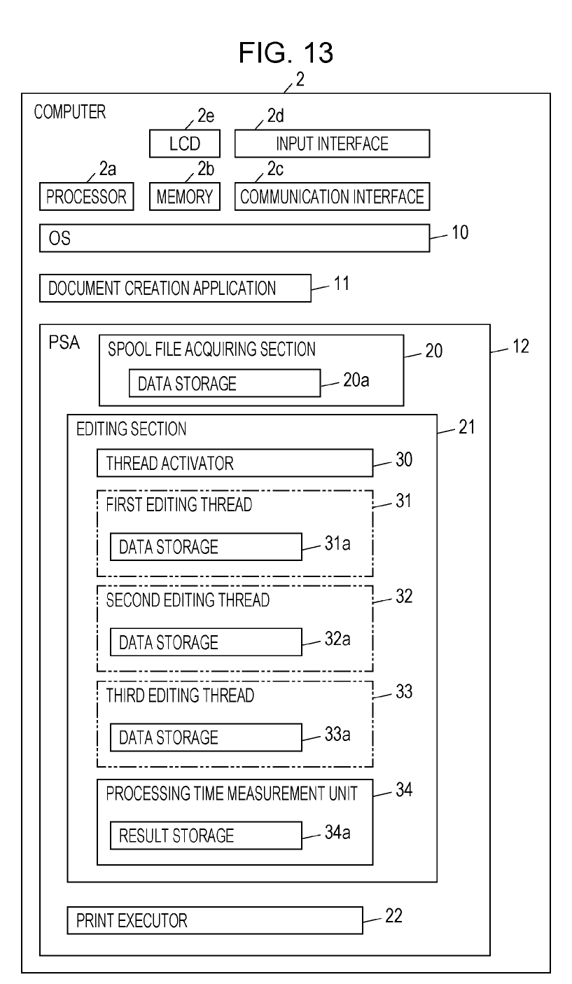

Hereafter, a second embodiment of the present disclosure will be described with reference to FIGS. 13 to 15. In the following, differences between the present embodiment and the first embodiment will be mainly described, and repeated descriptions are omitted for brevity.

In the present embodiment, the editing section 21 further includes a processing time measurement unit 34. The processing time measurement unit 34 measures the processing time of each of the plurality of editing processes. Specifically, the processing time measurement unit 34 measures the processing time of each of Editing Processes 6 to 11, which can be executed in a rearranged order. The processing time measurement unit 34 then stores the measurement results in a result storage 34a. The measurement result of the processing time of each of Editing Processes 6 to 11 is stored in the result storage 34a.

For example, regarding Editing Process 6, the processing time measurement unit 34 measures the processing time of Editing Process 6 each time Editing Process 6 is executed. Therefore, the processing time measurement unit 34 measures the processing time of Editing Process 6 multiple times. Then, the processing time measurement unit 34 stores the average value of the processing times of Editing Process 6 in the result storage 34a. The same applies to Editing Processes 7 to 11.

When executing a plurality of editing processes for each spool file, the thread activator 30 executes, among the plurality of editing processes, an editing process having a relatively long processing time prior to an editing process having a relatively short processing time. Specifically, assume that the plurality of editing processes to be executed on each spool file include Editing Processes 7, 8, and 11, and the processing time of Editing Process 11 is longer than the processing time of each of Editing Processes 7 and 8. It is also assumed that, as in the first embodiment, the thread activator 30 activates the first editing thread 31, the second editing thread 32, and the third editing thread 33. In this case, in order to execute Editing Process 11 earlier than Editing Processes 7 and 8, the thread activator 30 activates the first editing thread 31, the second editing thread 32, and the third editing thread 33 so that the first editing thread 31 executes Editing Process 11, the second editing thread 32 executes Editing Process 7, and the third editing thread 33 executes Editing Process 8.

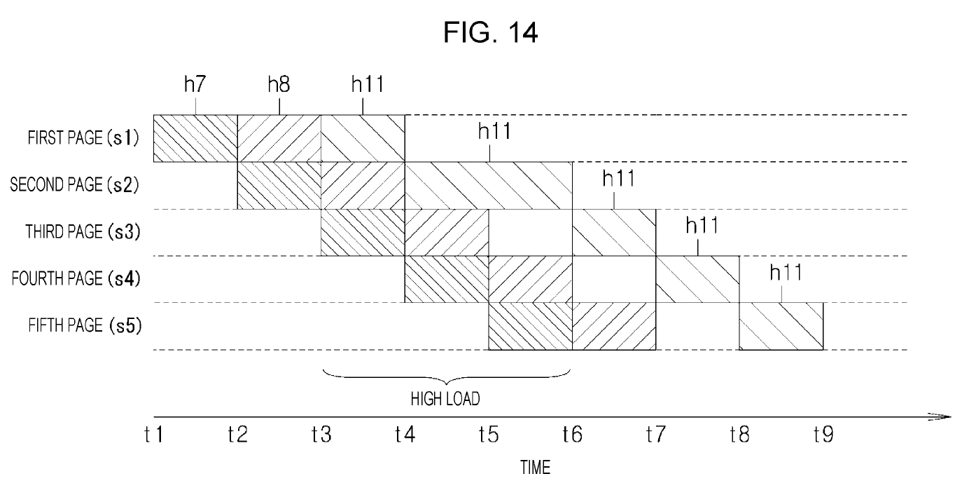

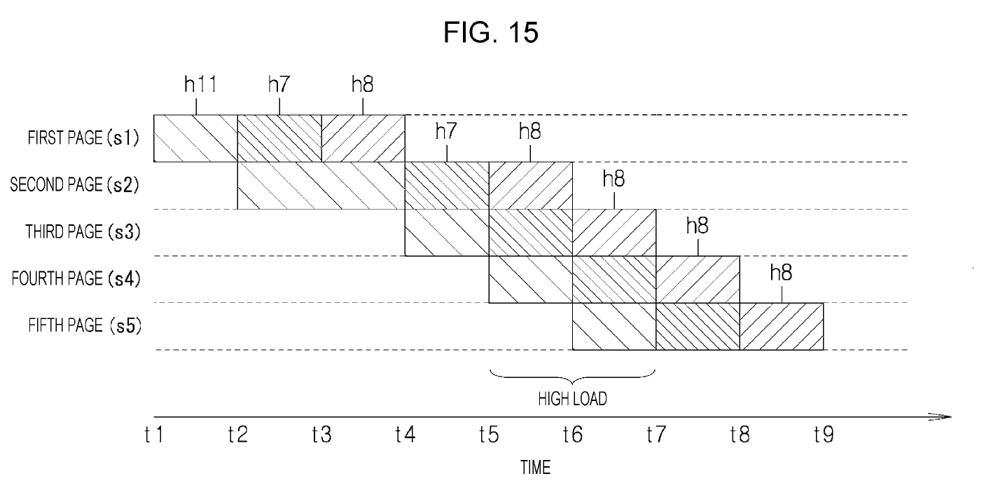

The technical significance of the present embodiment will be described with reference to FIGS. 14 and 15. FIG. 14 illustrates a timetable in a case where an editing process having a relatively long processing time is executed later than editing processes each having a relatively short processing time. FIG. 15 illustrates a timetable in a case where an editing process having a relatively long processing time is executed earlier than editing processes each having a relatively short processing time.

In FIG. 14, an editing process h7 corresponds to Editing Process 7, an editing process h8 corresponds to Editing Process 8, and an editing process h11 corresponds to Editing Process 11. The editing section 21 executes the editing processes h7, h8, and h11 as the plurality of editing processes. It is also assumed that the editing section 21 edits the first spool file s1, the second spool file s2, the third spool file s3, a fourth spool file s4, and a fifth spool file s5 as the plurality of spool files to be edited. The first to fifth spool files s1 to s5 respectively correspond to the first to fifth pages of the document.

As illustrated in FIG. 14, when the editing process (Editing Process 11) having a relatively long processing time is executed after the editing processes (Editing Processes 7 and 8) each having a relatively short processing time, the time period (from time t3 to time t6) during which the processor 2a experiences a high load is long. That is, from time t3 to time t6, the three cores of the processor 2a simultaneously generate heat. In contrast, as illustrated in FIG. 15, when the editing process (Editing Process 11) having a relatively long processing time is executed before the editing processes (Editing Processes 7 and 8) each having a relatively short processing time, the time period (from time t5 to time t7) during which the processor 2a experiences a high load is short. That is, from time t5 to time t7, the three cores of the processor 2a simultaneously generate heat. Accordingly, executing the editing process (Editing Process 11) having a relatively long processing time before the editing processes (Editing Processes 7 and 8) each having a relatively short processing time reduces the load of the processor 2a.

The second embodiment has been described above. This embodiment has the following features. That is, the editing section 21 measures the processing time of each of the plurality of editing processes, and executes, among the plurality of editing processes, an editing process having a relatively long processing time prior to an editing process having a relatively short processing time. This configuration reduces the time during which the processor 2a is in a high-load state, thereby reducing the load on the processor 2a.

Although the present disclosure has been described through the embodiments, the present disclosure is not limited to the above description. Various changes that can be understood by those skilled in the art may be made to the configuration and details of the present disclosure within the scope of the disclosure.

In the above example, the program can be stored using various types of non-transitory computer-readable media and can be supplied to the computer. The non-transitory computer-readable media include various types of tangible storage media. Examples of non-transitory computer-readable media include magnetic recording media (for example, a floppy disk, magnetic tape, and hard disk drive) and magneto-optical recording media (for example, a magneto-optical disk). Further examples include a compact disc read- only memory (CD-ROM), a CD-recordable (CD-R) medium, a CD-rewritable (CD-RW) medium, and a semiconductor memory (for example, mask ROMs). Additional examples include a programmable ROM (PROM), an erasable PROM (EPROM), a flash ROM, and a random-access memory (RAM). The program may also be supplied to the computer by various types of transitory computer-readable media. Examples of the transitory computer-readable media include an electric signal, an optical signal, and an electromagnetic wave. The transitory computer-readable media can supply a program to a computer via a wired communication channel, such as a line or optical fiber, or a wireless communication channel.

What is claimed is:

1. A non-transitory computer-readable storage medium storing a print control program that causes a computer to function as a print extension application for extending a general-purpose printer driver,
the print extension application including:
a print data acquisition unit configured to acquire a plurality of pieces of print data from the general-purpose printer driver; and
an editing unit configured to execute a plurality of editing processes on each of the plurality of pieces of print data by parallel processing.

2. The non-transitory computer-readable storage medium according to claim 1, wherein
the plurality of pieces of print data include first print data and second print data,
the plurality of editing processes include a first editing process and a second editing process different from the first editing process, and
the editing unit is configured to execute the first editing process and the second editing process on the first print data, and to execute the first editing process and the second editing process on the second print data.

3. The non-transitory computer-readable storage medium according to claim 2, wherein
the editing unit includes a first processing unit configured to execute the first editing process and a second processing unit configured to execute the second editing process.

4. The non-transitory computer-readable storage medium according to claim 3, wherein
after the first processing unit executes the first editing process on the first print data, the first processing unit executes the first editing process on the second print data while the second processing unit executes the second editing process on the first print data.

5. The non-transitory computer-readable storage medium according to claim 1, wherein
the editing unit is configured to
measure a processing time of each of the plurality of editing processes, and
execute, among the plurality of editing processes, an editing process having a relatively long processing time prior to an editing process having a relatively short processing time.

6. The non-transitory computer-readable storage medium according to claim 1, wherein
the print extension application is a print support application.

7. A print control apparatus comprising:
a general-purpose printer driver; and
a print extension application for extending the general-purpose printer driver,
the print extension application including
a print data acquisition unit configured to acquire a plurality of pieces of print data from the general-purpose printer driver, and
an editing unit configured to execute a plurality of editing processes on each of the plurality of pieces of print data by parallel processing.

8. A control method for a print control apparatus including
a general-purpose printer driver, and
a print extension application for extending the general-purpose printer driver,
the control method comprising:
acquiring, by the print extension application, a plurality of pieces of print data from the general-purpose printer driver; and
executing, by the print extension application, a plurality of editing processes on each of the plurality of pieces of print data by parallel processing.
